(19) United States
(12) Patent Application Publication
(10) Pub. No.: US 2015/0058521 A1
(43) Pub. Date: Feb. 26, 2015

(54) DETECTION OF HOT PAGES FOR PARTITION HIBERNATION

(71) Applicant: International Business Machines Corporation, Armonk, NY (US)

(72) Inventors: Troy D. ARMSTRONG, Rochester, MN (US); Daniel C. BIRKESTRAND, Rochester, MN (US); Wade B. OUREN, Rochester, MN (US); Edward C. PROSSER, Rochester, MN (US); Kenneth C. VOSSEN, Oronoco, MN (US)

(73) Assignee: International Business Machines Corporation, Armonk, NY (US)

(21) Appl. No.: 14/055,946

(22) Filed: Oct. 17, 2013

Related U.S. Application Data
(63) Continuation of application No. 13/973,682, filed on Aug. 22, 2013.

(51) Int. Cl. G06F 12/10; G06F 9/455

(52) U.S. Cl. CPC G06F 12/1009; G06F 9/45533
USPC 711/6

(57) ABSTRACT

Embodiments described herein identify hot pages associated with a virtual machine that is selected for hibernation or for migration from one computing system to another. For example, before hibernating a virtual machine, a hypervisor monitors the entries in a page table (i.e., a virtual translation table) to see what data pages have corresponding entries in the page table. If a data page has a corresponding entry in the page table, the hypervisor may designate that page as hot. In one embodiment, the hypervisor may update a page map that lists the data pages associated with the virtual machine and whether those data pages are designated as hot. The page map may then be stored during the hibernation process. Before the hibernated virtual machine is resumed, the hypervisor may use the page map to load the hot pages into memory and begin executing the virtual machine.

### CROSS-REFERENCE TO RELATED APPLICATION

This application is a continuation of co-pending U.S. patent application Ser. No. 13/973,682, filed Aug. 22, 2013. The aforementioned related patent application is herein incorporated by reference in its entirety.

### BACKGROUND

Computing systems may host one or more virtual machines (also referred to as logical partitions) which are themselves software implementations of a computing system. The virtual machines emulate the computer architecture and functions of a physical computing system. In one embodiment, the computing system hosting the virtual machines may determine to hibernate one or more of the machines. Once the virtual machine is hibernated, the computing system may then reassign the hardware resources assigned to the hibernated virtual machines to other computing elements in the system such as another virtual machine or a client application.

The strategy used to resume the hibernated virtual machine may determine the time needed for the virtual machine to again begin executing on the computing system. Beginning to execute the virtual machine early in the resumption process may cause the applications executed by the virtual machine to be delayed by frequent page faults. On the other hand, executing the virtual machine after loading all the data associated with a virtual machine into memory minimizes page faults but may cause an undesirable delay.

### SUMMARY

Embodiments included herein are a method and a computer program product that identify hot data pages associated with a virtual machine hosted by a computing system by monitoring entries in a page table stored in the computing system where the entries of the page table are used to perform a memory address translation between a virtual address space associated with the virtual machine and a physical address space associated with the computing system. Before hibernating the virtual machine, the method and computer program product save the identified hot pages into storage. The method and computer program product determine to resume the hibernated virtual machine, upon determining that the hot pages have been loaded from storage into memory of the computing system, resume the virtual machine.

Another embodiment included herein is a computing system that includes memory, a virtual machine loading into memory, and a hypervisor configured to manage the virtual machine. The hypervisor is configured to identify hot data pages associated with the virtual machine by monitoring entries in a page table stored in the computing system where the entries of the page table are used to perform a memory address translation between a virtual address space associated with the virtual machine and a physical address space associated with the computing system. Before hibernating the virtual machine, the hypervisor is configured to save the identified hot pages into storage associated with the computing system. The hypervisor is configured to determine to resume the hibernated virtual machine and, upon determining that the hot pages have been loaded from storage into memory of the computing system, resume the virtual machine.

### BRIEF DESCRIPTION OF THE SEVERAL VIEWS OF THE DRAWINGS

FIG. 1 illustrates a computing system for hosting one or more virtual machines, according to one embodiment described herein.

FIG. 2 is a flow chart for identifying hot pages when hibernating a virtual machine, according to one embodiment described herein.

FIG. 3 is a flow chart for updating a page map based on entries in a page table to identify hot pages for resuming a hibernated virtual machine, according to one embodiment described herein.

FIG. 4 illustrate a page map, according to one embodiment described herein.

FIG. 5 illustrates source and target computing systems for migrating a virtual machine, according to one embodiment described herein.

FIG. 6 is a flow chart for migrating a virtual machine by identifying hot pages, according to one embodiment described herein.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments described herein identify hot pages associated with a virtual machine that is selected for hibernation or for migration between computing systems. For example, before hibernating a virtual machine, a hypervisor may monitor the virtual machine during a monitoring period to identify the data pages accessed by the virtual machine. In one embodiment, the hypervisor monitors the entries in a page table (i.e., a virtual translation table) to see what data pages associated with the virtual machine have corresponding entries in the page table. If a data page has a corresponding entry in the page table, the hypervisor designates that page as hot. In one embodiment, the hypervisor may update a page map that lists the data pages in the computing system and whether those data pages are deemed hot. The page map may then be stored during the hibernation process along with other data associated with the virtual machine. Once the virtual machine is resumed, the hypervisor may use the page map to load the hot pages into memory. Upon doing so, the computing device may resume execution of the virtual machine. While the virtual machine executes, the remaining data associated with the virtual machine may be loaded into memory.

When migrating a virtual machine from a source computing system to a target computing system, the hypervisor may also use the page map to identify hot pages associated with the virtual machine. For example, upon determining to migrate the virtual machine, the hypervisor may begin to monitor the entries in the page table during the monitoring period. The source computing system may then transmit the hot data pages to the target computing system. Once the monitoring period expires and the hot data pages are transferred to the target computing system, the source computing system may cease execution of the virtual machine while the target computing system begins executing the virtual machine using the hot pages. The rest of the data pages associated with the virtual machine—i.e., the data pages that did not have corresponding entries in the page table during the monitoring period—may then be transmitted to the target computing system.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

### Hibernating and Resuming a Virtual Machine

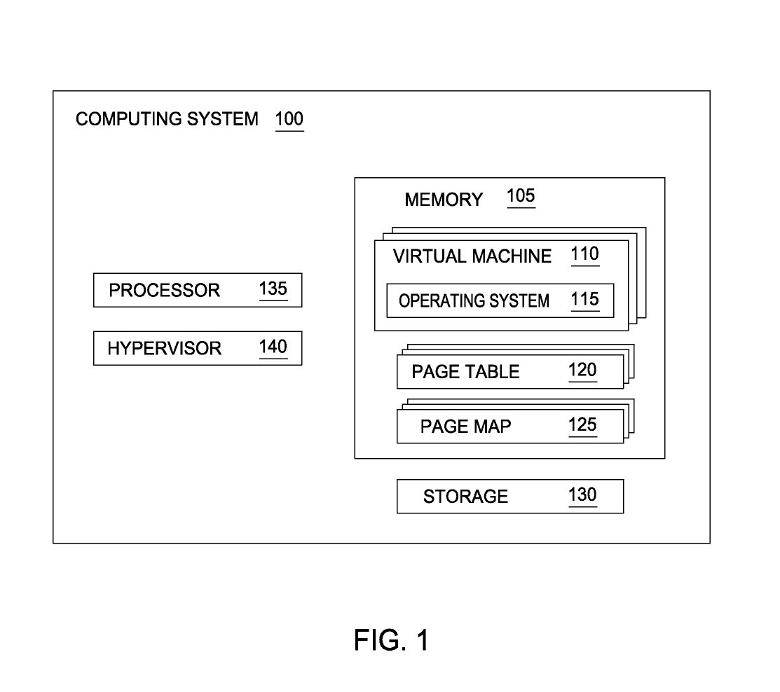

FIG. 1 illustrates a computing system 100 for hosting one or more virtual machines 110, according to one embodiment described herein. The computing system 100 includes a processor 135, hypervisor 140, memory 105, and storage 130. The processor 135 may be any processor capable of performing the functions described herein. Computing system 100 may include only one processor 135 or have multiple processors 135. Furthermore, each processor 135 may include one or more processing cores.

The hypervisor 140 may be firmware, hardware, or a combination of both that manages the virtual machines 110 hosted by the computing system 100. Generally, the hypervisor 140 serves as an intermediary between the physical, hardware resources of the computing system 100 and the virtual machines 110 executing on the system 100. For example, the hypervisor 140 may assign specific hardware resources in the system 100, such as a processor 135 or portions of the memory 105, to the virtual machines 110. In one embodiment, the hypervisor 140 may ensure that the virtual machines 110 do not use hardware resources assigned to a different virtual machine 110. For example, the hypervisor 140 may ensure that a first virtual machine 110 does not access data stored in memory 105 that is associated with a second virtual machine 110.

Memory 105 may be any memory that is external to the processor 135 in the computing system 100—i.e., is not built into the integrated circuit of the processor 135. For example, the main memory 125 may include one or more levels of cache memory as well as random access memory (RAM) but may, in one embodiment, exclude external storage networks or hard disk drives. Memory 105 may be volatile or non-volatile memory such as DRAM, SRAM, Flash memory, resistive RAM, and the like.

Memory 105 may store one or more virtual machines 110, page tables 120, and page maps 125. Each of these elements will be discussed in turn. The virtual machine 110 includes an operating system 115 that may execute various applications. The computing system 100 may host a plurality of virtual machines 110 where each machine 110 includes its own operating system 115 that may execute independently of the other operating systems 115. In one embodiment, the operating systems 115 may use a virtual memory address space to reference pages of data stored in the computing system 100. However, the computing system 100 may use a physical memory address space to reference the same data pages. Thus, in order for the operating system 115 to use the physical hardware resources (e.g., memory 105) to store data associated with the virtual machines 110, the hypervisor 140 may perform virtual-to-physical or physical-to-virtual address translations. Permitting the operating systems 115 in the virtual machines 110 to use virtual memory address enables the computing system 100 to store the data pages at any physical address, even if the data pages are not stored in contiguous memory locations. To perform the address translation, memory 105 includes the page table 120 (also referred to as a page translation table or hardware page table) which the system 100 (e.g., processor 135) may use to translate virtual memory addresses to physical memory addresses and vice versa.

To retrieve a data page, an operating system 115 may send a request to the processor 135 which uses the virtual memory address provided by the operating system 115 to parse through the entries in the page table 120 that map the virtual addresses to the physical addresses. Once the system 100 identifies an entry with the virtual address, the processor 135 may use the corresponding physical address in the entry to retrieve the data from memory 105 (or storage 130) and return the data page to the operating system 115. In this manner, the operating system 115 may use a range of contiguous virtual memory addresses even though the corresponding data pages may be stored at physical addresses that do not form a contiguous block of physical memory in the computing system 100.

In one embodiment, each virtual machine 110 may be associated with a respective one of the page tables 120. The computing system 100 may use the page tables 120 as caches of virtual-to-physical mappings that may increase the performance of the hardware in the computer system 100 when performing memory load and store operations.

In one embodiment, the page table 120 may not maintain a complete list of entries that maps every virtual address associated with the virtual machines 110 to a corresponding physical memory address in computing system 100. Instead, the page table 120 may store only a subset of these entries. If the processor 135 receives a request for data at a virtual address that does not have an entry in the page table 120, the system 100 may signal an interrupt to the hypervisor 140 which will then add a page table entry to the page table 120. The hypervisor 140 may also evict an entry in the page table 120 to keep the size of the table 120 constant. For example, the hypervisor 140 may use a least-recently used policy in order to determine which entry to evict when a new entry is added to the page table 120. The hypervisor 140 may then instruct the processor 135 to again attempt to retrieve the data page requested by the virtual machine 110.

The page map 125 may be a data structure used by the computing system 100 to identify hot data pages associated with a particular virtual machine 110—i.e., the system 100 may generate a separate page map 125 for each virtual machine 110. The term “hot” data page is used herein to indicate a data page associated with a virtual machine that is loaded into memory 105 before resuming a hibernated virtual machine 110. As will be discussed in more detail below, the hypervisor 140 may store in the page map 125 an indicator of what data pages associated with the virtual machine 110 are hot—e.g., which data pages the virtual machine 110 is likely (or predicted) to need when resuming execution. When hibernating the virtual machines 110, the hypervisor 140 may store the page map 125 into storage 130. Upon receiving a prompt to resume the virtual machine 110, the hypervisor 140 may load the data pages indicated as hot in the page map 125 into memory 105. Once the hot pages are loaded, the hypervisor 140 may resume (i.e., begin executing) the virtual machine 110.

Storage 130 may be represent data storage used by computing system 100 that is not the memory 105. For example, in one embodiment, storage 130 may include internal or external hard disk drives or network storage devices communicatively coupled to the computing system 100. In one embodiment, storage 130 may exclude cache memory and RAM that are included in memory 105.

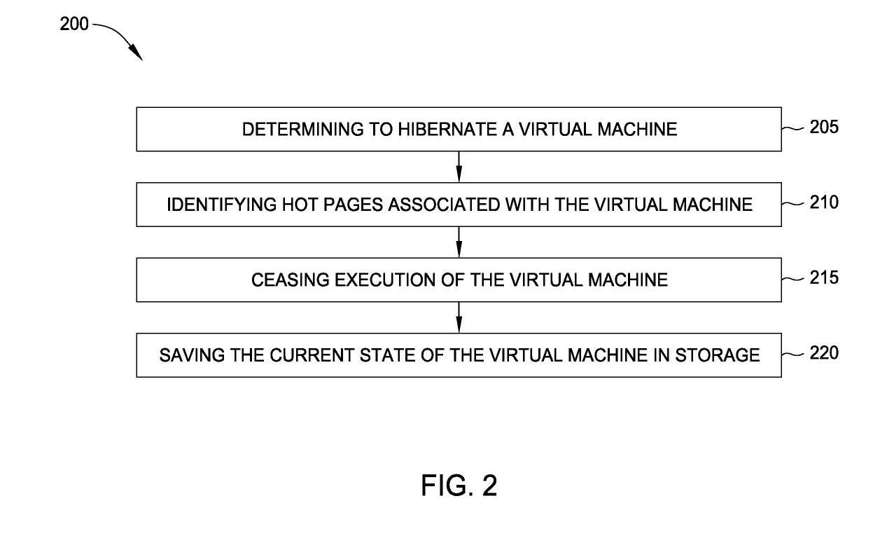

FIG. 2 is a flow chart 200 for identifying hot data pages when hibernating a virtual machine, according to one embodiment described herein. At block 205, the hypervisor may receive a prompt to hibernate a virtual machine executing on the computer system. The computing system may determine to hibernate the virtual machine for any number of reasons such as the virtual machine is infrequently used, to perform maintenance on the computing system, or the computing system wants to reassign hardware resource associated with the virtual machine to other computing element. Although the hypervisor may receive a request to hibernate the virtual machine, in another embodiment, the hypervisor may itself include logic for determining whether to hibernate a virtual machine. For example, if the virtual machine is no longer executing applications or if a higher-priority virtual machine needs the resource assigned to the virtual machine, the hypervisor may decide to hibernate the virtual machine.

At block 210, the hypervisor may identify the hot pages associated with the virtual machine. In one embodiment, the hypervisor may monitor the data pages referenced by entries in the page table assigned to the virtual machine. For example, the hypervisor may identify hot pages when a processor sends an interrupt after a virtual machine requests a data page that does not have a corresponding entry in the page table. As discussed above, the hypervisor may add the required entry to the page table, and thus, determine that the data page referenced by that page entry is hot.

If a data page is referenced by an entry in the page table, the hypervisor may update the page map to indicate that the data page is hot. In one embodiment, the page map may include an entry for each data page associated with the virtual machine. The page map may include a flag or bit that indicates whether the page is designated as a hot page.

In one embodiment, the hypervisor may identify the hot pages by evaluating the entries in the page table during a monitoring period (e.g., thirty seconds). Once the monitoring period expires, the hypervisor may proceed with hibernating the virtual machine. Alternatively, in another embodiment, the hypervisor may continually monitor the page table, and thus, constantly (or at predefined intervals) update the page map to flag the hot data pages. For example, the hypervisor may clear out the page map at a predefined interval (e.g., every five minutes) and monitor the entries in the page table for thirty seconds in order to again identify the hot pages. Thus, once the prompt to hibernate is received, the hypervisor may begin to hibernate the virtual machine using the current page map without first monitoring the page table during the monitoring period to identify the hot data pages.

At block 215, the hypervisor may cease execution of the virtual machine. For example, the hypervisor may no longer give virtual processors assigned to the virtual machine any processor cycles. In one embodiment, the applications executed on by the virtual machine's operating system are also paused. Thus, if an application is in the middle of performing an operation, the operating system may pause the application such that the data pages are no longer being read from or written into memory.

At block 220, the hypervisor saves the current state of the virtual machine. Stated differently, the hypervisor may save all the data required in order to resume the virtual machine in the same state the virtual machine was in at the time the virtual machine was halted at block 215. When resumed, the same applications executing on the virtual machine may be in the same state even if these applications were in the middle of an operation when the virtual machine was hibernated. To save the current state of the virtual machine, the hypervisor may save the page table associated with the virtual machine, the data pages associated with the virtual machine, state of the processor, data used by the hypervisor when managing the virtual machine, and the like. In addition to this data, the hypervisor may also store the page map that indicates which of the data pages associated with the virtual machine are hot. Referring to FIG. 1, when saving the state of the virtual machine 110, the associated data may be saved in storage 130 (e.g., a hard disk or network storage). Doing so may allow the computing system to remove the data from memory 105 and free up additional address space in memory 105.

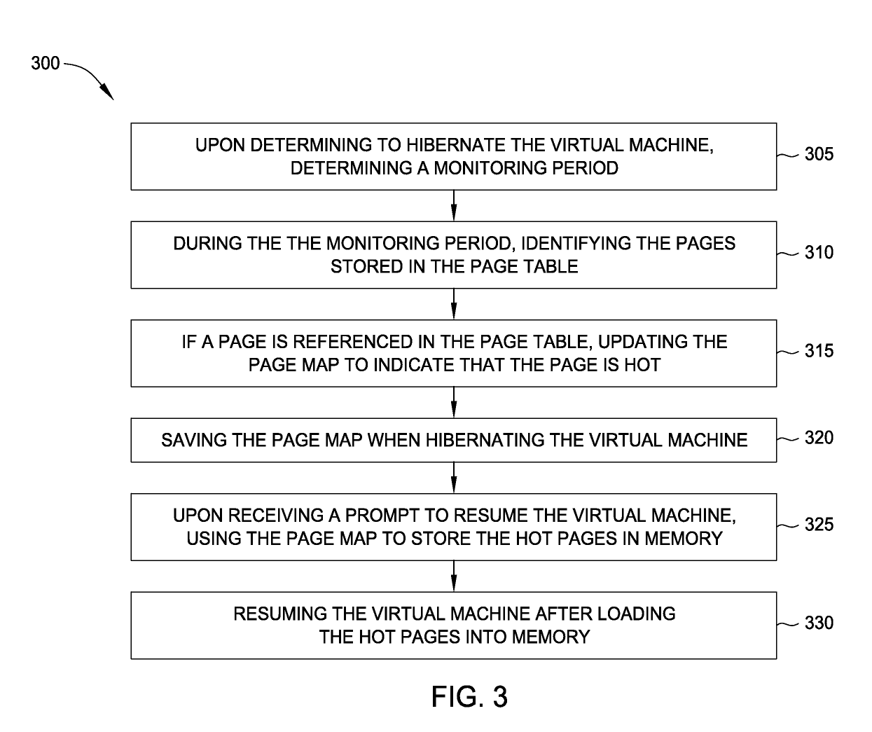

FIG. 3 is a flow chart 300 for updating a page map based on entries in a page table to identify hot pages for resuming a hibernated virtual machine, according to one embodiment described herein. At block 305, the hypervisor may receive a prompt to hibernate a virtual machine. As discussed in flow chart 200 of FIG. 2, in another embodiment, the hypervisor uses control logic to independently determine whether to hibernate a virtual machine. Regardless of how the hypervisor determines to hibernate the virtual machine, before doing so, the hypervisor may identify a monitoring period during which time the hypervisor monitors the entries in a page table associated with the virtual machine. The duration of the monitoring period may be predetermined (e.g., set to thirty seconds) or may be dynamically adjusted by the hypervisor based on one or more criteria. For example, the hypervisor may determine the duration of the monitoring period based on a priority value associated with the virtual machine or the utilization of a processor or memory partition assigned to the virtual machine. If the virtual machine has a high-priority or has high processor utilization, the hypervisor may increase the duration of the monitoring period. Doing so increases the time delay before the virtual machine hibernates, but as discussed later, may increase the performance of the virtual machine when it is resumed.

At block 310, the hypervisor may identify the hot pages by monitoring the entries in the page table during the monitoring period. As discussed above, the page table is used by the processor when translating addresses between the virtual addresses used by the virtual machines to the physical addresses used in physical memory, and vice versa. The entries in the page table may vary, however. That is, as a virtual machine requests a data page whose virtual address is not in the page table, the processor may request that the hypervisor add a new entry to the page table and evict a current entry form the table. If during the monitoring period a data page has a corresponding entry in the page table—e.g., the physical address where the data page is stored is saved in the page table—the hypervisor may designate the data page as hot.

At block 315, during the monitoring period, the hypervisor may monitor the entries in the page table to identify the hot data pages. In one embodiment, the hypervisor may scan the entries to identify all the data pages corresponding to addresses stored in the page table. The hypervisor may then mark these data pages as hot in the page map. However, this may identify data pages that have been referenced in the page table for a long time (e.g., hours) and may likely not be needed by the virtual machine when resuming execution. Alternatively or additionally, as the virtual machine continues to execute as normal during the monitoring period, the hypervisor monitors the page table and determines when new entries are added to the page table. The data pages referenced by these new entries may also be marked as hot pages in the page map. Designating hot pages based on entries in the page table is based on the assumption that these data pages are important to the virtual machine—i.e., the operating system or applications executing on the virtual machine are accessing these data pages. Thus, if the hot pages are the pages most recently referenced in (or added to) the page table before hibernating the virtual machine, it is assumed or predicted that these data pages will be accessed by the virtual machine when it awakes from hibernation.

At block 320, the hypervisor may save the page map along with the other data needed to preserve the current state of the virtual machine. As discussed above, this data may be saved in a non-volatile storage device such as a disk drive.

At block 325, the hypervisor may receive a prompt to resume the virtual machine. There are several methods for resuming a hibernated virtual machine. In a first example, the hypervisor may load the essential structures into memory, for example the page table and other hypervisor tables associated with the virtual machines which allows the virtual machine to start executing as soon as possible. However, because the data pages associated with the applications and operating system are not loaded into memory, the virtual machine will experience frequent page faults which require the computing system to fetch the corresponding data pages which were saved during hibernation from the storage device. Doing so may require significantly more processor clock cycles than fetching data pages from memory. Accordingly, although this technique begins executing the virtual machine quickly, its performance is limited due to the frequent occurrence of page faults.

A second example for resuming the virtual machine is loading all the data pages associated with the virtual machine into memory before beginning to execute the virtual machine. Doing so may eliminate page faults but the time required to transfer the data pages from storage into memory delays execution of the virtual machine. For example, the virtual machine may have a terabyte worth of data pages that are saved in storage when the virtual machines hibernates, however, when resumed, the virtual machine may be currently accessing only a portion of that data. Specifically, the operating system and applications executing on the virtual machine when resumed may need to access only twenty-five percent of the data pages yet the execution of the virtual machine is delayed until all of the data pages are loaded into memory.

A third example for resuming the virtual machine is to use the page map to load the designated hot data pages into memory before executing the virtual machine. In contrast to loading only the essential data needed to execute the virtual machine as done in the first example, in this example, the hypervisor loads the hot pages into memory before executing the virtual machine. Because the hot pages are data pages recently requested by the applications or operating system on the virtual machine before being hibernated, the hypervisor predicts that the hot pages will be the data pages needed by the virtual machine in the immediate future. In this manner, loading the hot pages may minimize the page faults when compared to the first example. Thus, loading the hot pages into memory may improve the performance of the virtual machine when compared to the first example.

Moreover, the third example may result in the virtual machine beginning to execute with a shorter delay when compared to using the second example. That is, instead of waiting until all the data pages associated with the virtual machine are transferred from storage into memory, the virtual machine in this example begins to execute once the hot pages are loaded. For example, if the hot pages includes only twenty-five percent of the total data pages saved during hibernation, the virtual machine in the third example is able to avoid the delay for loading the other seventy-five percent of the data pages into memory. While the virtual machine is executing using the hot pages, the hypervisor may load the other seventy-five percent of the data pages into memory in the background. Thus, in one embodiment, the hot pages represent the data pages that the virtual machine will likely need in the near future. While the virtual machine executes using the hot pages, the hypervisor loads the rest of the data pages into memory. Thus, once the virtual machine needs the data pages that were not designated as hot, these data pages may are already be loaded into memory. Of course, if the virtual machine requires a data page that was not designated as hot before that data page is loaded into memory, the computer system may fault-in the data page using an interrupt. Nonetheless, method 300 reduces the number of faults when compared to the first example by predicting what data pages will be needed by the virtual machine.

Although the third example may delay hibernating the virtual machine to permit the identification of hot pages during the monitoring period (assuming the hypervisor does not continually maintain a list of hot pages), it may be preferred to delay hibernation if doing so result in increased performance when resuming the virtual machine. Thus, because the third example may reduce the number of page faults when compared to the first example and reduce the delay for executing the virtual machine when compared to the second example, any delay before hibernating the virtual machine may be acceptable.

In one embodiment, the monitoring period may be adjusted to determine the number of hot pages identified by the hypervisor. For example, shrinking the monitoring period may identify less hot pages and allow the hypervisor to begin hibernating the virtual machine quicker. Because there may be fewer hot pages to load, the virtual machine may begin execution quicker when the hypervisor determines to resume the virtual machine. However, the virtual machine may experience an increased number of page faults if the virtual machine requests non-hot data pages that have not yet been loaded into memory. On the other hand, increasing the monitoring period may identify more hot pages and may reduce the number of page faults when the virtual machine resumes execution. However, resuming the virtual machine is delayed as the hot pages, which may be greater in number than when a shorter monitoring period is use, are loaded into memory. Thus, one of ordinary skill in the art will recognize that the monitoring period may be adjusted to suit the needs and configuration of a particular computing system.

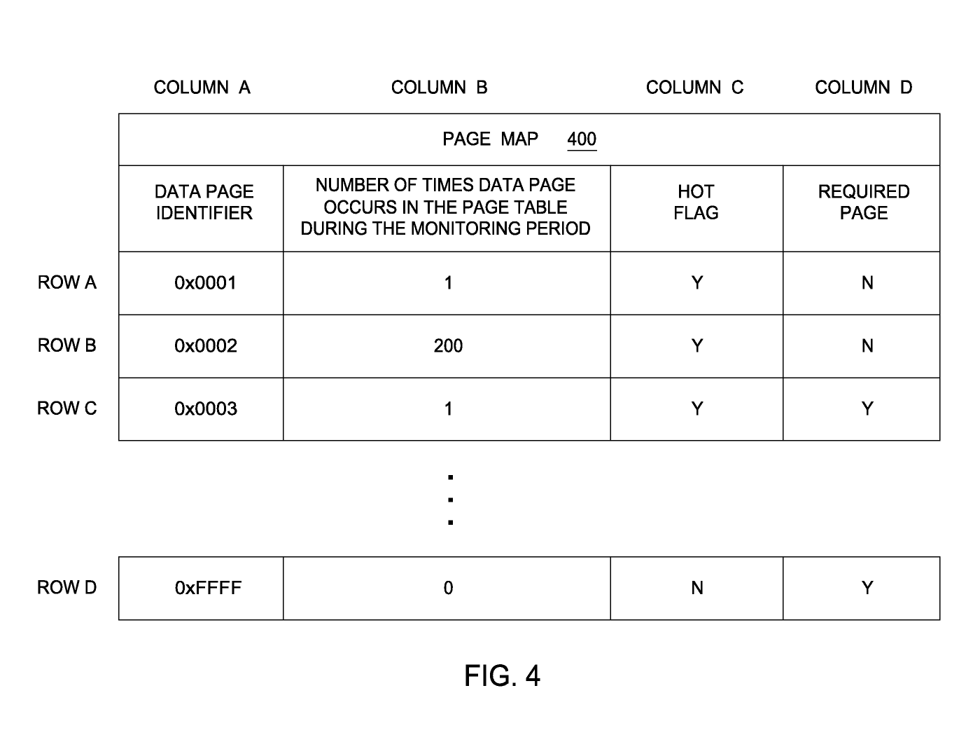

FIG. 4 illustrate a page map 400, according to one embodiment described herein. The data structure shown in FIG. 4, however, is just one example of arranging information in the page map 400. As shown, page map 400 has four columns which indicate different information that may be stored within a particular entry or row in the map 400. Column A may be used as a data page identifier. In this example, page map 400 uses the virtual address associated with the data page to identify all the data pages associated with a particular virtual address, but in other examples the identifier may be the physical address of the data page or some other identifier. In one embodiment, the hypervisor may generate a new page map 400 for each virtual machine that is hibernated. The page map 400 may include an entry for every data page associated with the virtual machine that is stored in memory, but this is not a requirement. In one embodiment, the hypervisor may store only the data pages that are designated as hot in the page map 400. Thus, by virtue of not being referenced in the page map 400 by a data page identifier, the hypervisor may know that the data page is not hot, and thus, it will likely not reduce page faults if the data page is loaded into memory before the virtual machine is resumed.

Column B is a count of the number of times the data page (or a reference to the data page) appears in the page table during the monitoring period. For example, an entry referring to the data page may be added and evicted from a page table multiple times during the monitoring period. The hypervisor may increment the count stored in Column B each time an entry corresponding to the data page is added to the page table. Moreover, the page table may include multiple entries that refer to the same data page. In one embodiment, the hypervisor may increment the count in Column B every time the data page is referenced in the page table, even if that data page is referenced multiple times.

Column C of page map 400 stores a flag that indicates whether the data page referenced by that row is designated as hot. In one embodiment, so long as the count in Column B is greater than one, the hypervisor updates the flag in Column C to indicate that the corresponding data page is hot. State differently, so long as during the monitoring period the corresponding data page is referenced by at least one entry in the page table, the data page is designated as hot in Column C. In another embodiment, the hypervisor may wait until the count in Column B gets to a certain predetermined value before indicating that the data page is hot. However, this may not be preferred since the number of times a data page is referenced in the page table may not directly correlate with the likelihood that the virtual machine will need that data page when awaking from hibernation. For example, Row A illustrates a data page that is referenced only once by the page table during the monitoring period; however, the virtual machine may access the referenced data page thousands of times during the monitoring period. In contrast, Row B is referenced by 200 entries in the page table during monitoring period but that does not necessarily mean the data page was every accessed by the virtual machine. In one embodiment, the page map 400 may omit Column C and instead the hypervisor may determine if a data page is hot based on whether the value stored in Column B is non-zero or non-null.

In one embodiment, identifying hot page using the hypervisor may be supplemented by using the operating systems in the virtual machine. For example, while the hypervisor monitors the number of times the data pages are reference in the page table during the monitoring period, the operating system may determine the number of times the data pages are accessed—e.g., the data pages are read or modified. The information gathered by the operating system and the hypervisor may then be combined in order to identify which data pages are hot. For example, instead of relying solely on whether the data pages are referenced in the page table, the hypervisor may designate the pages as hot so long as the data pages referenced in the page table are accessed by the operating system a predefined number of times during the monitoring period.

Column D is a flag that indicates whether the data page is required, regardless of whether the data page is referenced in the page table during the monitoring period. For example, the data page may be a configuration file that is used when resuming a virtual machine. Because these pages may only be accessed when a virtual machine first begins executing, the data page may not be referenced in the page table during the monitoring period yet the hypervisor may ensure that this data page is loaded into memory before the virtual machine resumes execution. As shown by Row D, the corresponding data page was never referenced in the page table during the monitoring period, but because the flag in Column D is set to “y”, the hypervisor will load the corresponding data page into memory before resuming the virtual machine. Thus, the criteria for setting the state of the flag in Column D may be independent of the criteria used to set the flag in Column C.

### Migrating a Virtual Machine

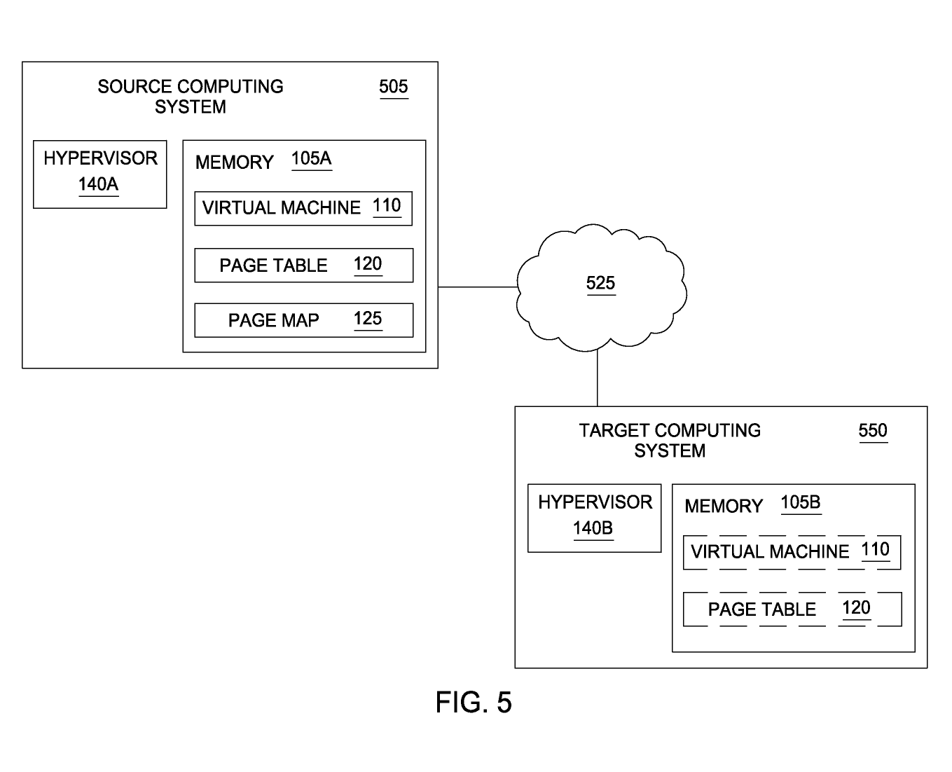

FIG. 5 illustrates source and target computing systems 505, 550 for migrating a virtual machine 110, according to one embodiment described herein. The source computing system 505 includes a hypervisor 140A and memory 105A. In one embodiment, these computing elements may be similar to the hypervisor 140 and memory 105 shown in FIG. 1. The source computing system 505 may host any number of virtual machines 110 that are managed by the hypervisor 140A. Although not shown, each virtual machine 110 may include a respective operating system for executing applications that process data stored in memory 105A or other storage element associated with the computing system 505.

In addition to virtual machine 110, memory 105A includes the page table 120 and page map 125. The page table 120 may be a hardware page table or a page translation table that is used to perform virtual to physical address translations. The hardware in the computing systems 505, 550 may use the page table 120 when servicing requests from the virtual machine 110 to access data pages stored in memory 105A. The entries in page table 120 may dynamically change based on the requests from the virtual machine 110 to access data. If a requested data page is not reference in the page table 120, the computing system hardware (e.g., a processor) may request that the hypervisor 140A generate a new entry in the page table 120. In one embodiment, the hypervisor 140A may use an eviction policy to remove an old entry in the page table 120, thereby maintaining the size of the table 120.

In addition to using a page map 125 when hibernating a virtual machine, the page map 125 may also be used when migrating the virtual machine 110 from the source computing system 505 to the target computing system 550. As will be discussed in more detail below, the hypervisor 140A may use the page map 125 to track the hot page associated with virtual machine 110. In one embodiment, the source computing system 505 may transfer the hot pages to the target computing system 550 before beginning to execute virtual machine 110 on system 550. The migration of the virtual machine 110 (and the page table 120) to the target computer system 550 is represented by the ghosted lines.

To migrate the virtual machine between computing systems 505 and 550, the systems 505, 550 are communicatively coupled via network 525. The network 525 may be, for example, a LAN or WAN, where the computing systems 505 and 550 use Ethernet connections to transfer data. In another embodiment, the computing systems 505 and 550 may use a direct link rather than network 525 to share data. For example, the systems 505, 550 may use PCIe or InfiniBand® connection to transfer data associated with the virtual machine 110 (InfiniBand® is a register trademark of the InfiniBand Trade Association).

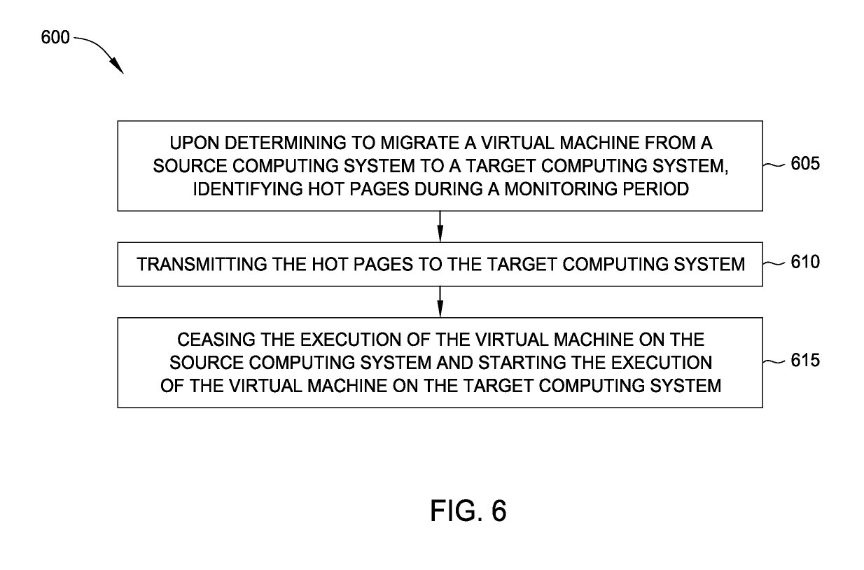

FIG. 6 is a flow chart 600 for migrating a virtual machine by identifying hot pages, according to one embodiment described herein. At block 605, the hypervisor on the source computing system may receive a prompt to migrate the virtual machine to the target computing system. Alternatively, the hypervisor may include internal logic for determining when to migrate the virtual machine. For example, a network administrator may send the prompt because the source computing system is going to be powered down to perform maintenance. Or the hypervisor may determine using its internal logic that a scheduled maintenance event is about to occur and that the virtual machine should be migrated to avoid a service outage.

Once the hypervisor determines that the virtual machine should be migrated, the hypervisor may begin to identify the hot pages associated with the virtual machine. As discussed previously, the hypervisor may use a monitoring period (whose duration can be predefined or dynamically determined) to monitor the entries of the page table in the source computing system. If a data page associated with the virtual machine is reference by one of the entries in the page table during the monitoring period, the hypervisor may flag the data page as hot in the page map. One example of a suitable page map may be found in the page map 400 shown in FIG. 4.

Alternatively, the hypervisor may maintain a current list of hot pages. Thus, once a prompt to migrate a virtual machine is received, the hypervisor may begin the migration process without first identifying the hot pages during the monitoring period. For example, during normal execution of the virtual machine, the hypervisor may clear out the page map at a predefined interval (e.g., every minute) and monitor the entries in the page table for five seconds in order to again identify the hot pages. Thus, once the prompt to migrate the virtual machine is received, the hypervisor may prioritize the hot pages identified in the page map as discussed below.

At block 610, the source computing system transmits the identified hot pages to the target computing system. In one embodiment, the hypervisor uses the page map to identify, retrieve, and transfer the hot pages stored in memory (or storage) at the source computing system to the target computing system. There, its hypervisor may then load the transferred hot pages into memory.

At block 615, once the hot pages have been transferred and loaded on the memory of the target computing system, the hypervisor on the source computing system may cease the execution of the virtual machine. At, or near, the same time, the hypervisor on the target computing system may begin executing the virtual machine. In addition to transmitting the hot pages, in one embodiment, the source computing system may transmit configuration files, processor state, the page table, and any other information that is needed for the target computing system to begin execution of the virtual machine in the same state the virtual machine was in when execution ceased.

In one embodiment, the hypervisors may wait until the monitoring period has expired before halting the virtual machine on the source computing system and starting the virtual machine on the target computing system. Moreover, during the monitoring period, the source computing system may transfer data pages as soon as the hypervisor designates the data pages as hot. That is, once a data pages is flagged as hot in the page map, the hypervisor may transfer that data page to the target computing system. However, if the hypervisor determines that the virtual machine has accessed a hot data page after the page was transferred, in one embodiment, the hypervisor may retransmit the data page to ensure the target computing system has the most current version of the data page. For example, the hypervisor may zero out a count associated with the data page in the page map the hypervisor transmits the hot data page to the target computing system. If the count is again incremented—e.g., the hypervisor generates a new entry in the page table referencing the transmitted data page—the hypervisor will again flag the data page for retransmission to the target computing system.

Alternatively, the hypervisor on the source computing system may wait until the monitoring period is expired before transmitting the hot pages to the target computing system. For example, during the monitoring period, the hypervisor may transfer the configuration files or other system setup information needed to begin execution of the virtual machine but wait until the period expires before sending the hot pages. Doing so may cause a delay during which the virtual machine on the source computing system has ceased execution but the target computing system has not begun execution. Once the hot pages are received, the target computing system may then begin executing the virtual machine. In contrast, transmitting the hot pages during the monitoring period may minimize this delay and allow for almost seemless operation of the virtual machine during the migration such that there is little or no downtime.

Transferring the hot pages before beginning to execute the virtual machine on the target computing system may increase performance relative to executing the virtual machine before the hot data pages are transferred to the target computing system. For example, if the virtual machine begins executing without the hot data pages loaded into the memory, frequent page faults will cause the target computing system to continually retrieve data from the source computing device. If a network is used to communicatively couple the source and target computing systems, the ability to retrieve the required data pages is limited to the network transfer speed which may severely limit the virtual machines performance. Furthermore, if the virtual machine is not executed until all the data pages are loaded onto the target computing system, there may be a substantial downtime. Instead, the hypervisor may use page map to identify and transfer hot pages to the target computing system. While the virtual machine executes on the target computing system using the hot data pages, in the background, the source computing system may continue to send the rest of the data pages (i.e., the non-hot data pages) to the target computing system. Stated differently, the hot pages provides the virtual machine with the data the virtual machine is likely to need in the near future. While the virtual machine executes using primarily the hot pages, the computing systems may use this time to transfer the rest of the data pages. Thus, at a later time when the virtual machine requests the non-hot pages, they will already be loaded into memory on the target computing system.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the foregoing is directed to embodiments of the present invention, other and further embodiments of the invention may be devised without departing from the basic scope thereof, and the scope thereof is determined by the claims that follow.

What is claimed is:

1. A method comprising:
identifying hot data pages associated with a virtual machine hosted by a computing system by monitoring entries in a page table, wherein the entries of the page table translate addresses in a virtual address space associated with the virtual machine to a physical address space associated with the computing system;
before hibernating the virtual machine, saving the identified hot pages into storage;
determining to resume operation of the hibernated virtual machine; and
upon determining that the hot pages have been loaded from storage into memory of the computing system, resuming the virtual machine.

2. The method of claim 1, wherein monitoring the entries in the page table comprises
identifying the hot data pages associated with the virtual machine that are referenced by the entries in the page table; and
upon determining a first data page is referenced by at least one entry in the page table, updating a page map to indicate that the first data page is one of the hot data pages, the page map containing information associated with the hot data pages included within the virtual address space of the virtual machine.

3. The method of claim 2, further comprising:
before hibernating the virtual machine, saving the page map into storage;
upon determining to resume operation of the hibernated virtual machine, using the page map to identify and load the hot pages from storage into memory of the computing system.

4. The method of claim 1, further comprising:
upon determining to hibernate the virtual machine, identifying the hot pages during a monitoring time defining a duration during which the computing system monitors the entries in the page table to identify the hot pages.

5. The method of claim 4, wherein the monitoring time begins after receiving a prompt to hibernate the virtual machine.

6. The method of claim 1, further comprising, after resuming the virtual machine, loading from storage into memory additional data pages associated with the virtual machine that were not identified as hot data pages.

7. The method of claim 1, wherein the hot data pages estimate of which data pages will be required by the virtual machine to execute upon being resumed.
